(19) United States
(12) Patent Application Publication
(10) Pub. No.: US 2019/0164449 A1
(43) Pub. Date: May 30, 2019

(54) COMPUTER-BASED SYSTEM FOR SCORING WEB SITE IMPLEMENTATIONS AGAINST DESIGN SPECIFICATIONS

(71) Applicant: General Assembly, Inc., New York, NY (US)

(72) Inventors: Taylor Kems, Ottawa, KS (US); Matthew Fritz, Littleton, CO (US); Matthew Smith, Congleton (GB); David Klein, San Francisco, CA (US); Kieran Luke, New York, NY (US); Jake Schwartz, New York, NY (US)

(21) Appl. No.: 15/824,543

(22) Filed: Nov. 28, 2017

(51) Int. Cl. G09B 19/00; G06K 9/62; G06F 8/34

(52) U.S. Cl. CPC G09B 19/0053; H04L 67/02; G06F 8/34; G06K 9/6202

(57) ABSTRACT

A computer-based, automated grading system us configured to receive human-generated source code in a machine-readable format to score the quality of the subject code against a target design specification. An assessment web application administers an assessment and receives a candidate submission that may be injected into a reference codebase, rendered in a browser, and processed by a mismatch generator and scorer to calculate a candidate submission score.

### BACKGROUND

As the web has become an essential—and even intertwined—element in modern commerce and society, web development and web developers have become an essential component in supporting that infrastructure, implementing in source code the designs of brand professionals, marketing and public relations agencies, graphic designers, and other professionals. Web developers provide the link between concept and implementation, and the skill of the web developer can have a powerful impact on the translation of an abstract design concept to reality.

Development of a large corporate or organizational web site can cost in excess of $100,000, before investment in online stores or other backend processing, a significant investment for any organization. An organization may be willing to make such a sizable investment because it relies greatly on a web presence to attract and retain visitors, make sales, and communicate a brand image. For many companies, the online presence is the primary means of communication with the public.

Despite the cost and criticality of web development to a modern company, methods for identifying and hiring developers are inconsistent and acquiring talent remains a challenge. The rise of the modern web has led to a high demand for web development professionals. The U.S. Bureau of Labor Statistics estimated that as of 2014, 1,485,000 web development positions existed, with an expected increase of 39,500 new jobs by 2024. See https://www.bls.gov/ooh/computer-and-information-technology/web-developers.htm. The growing popularity of mobile devices and e-commerce were cited as a driving factor for growth “much faster than the average for all occupations.”

For employers and recruiters, it can be expensive and time-consuming to select among technical job applicants. Technical assistance from an experienced web developer may be necessary to understand the quality of a work sample submitted by a candidate. This barrier limits the volume of candidates they can consider, forcing recruiters to use proxies such as education level and prior experience to winnow the field of applicants. Validating skills is an option for expanding the talent pool as individuals can now learn skills from a wide set of traditional and new sources including online, free, paid, boot camps and college. However, the validation process can become a bottleneck in the overall hiring process. For individuals, it is similarly cumbersome to measure the precise quality of their work against desired specifications.

Testing has also been employed to put the developer in a sample design and implementation scenario. where the developer is scored on how accurately he or she can implement the target design. While testing can provide guidance on how a candidate performs in a particular scenario, these systems have limitations. Human grading of website work product is variable, even when a clear grading rubric is provided. Human grading is also slow (in comparison to machine grading) and is capacity-constrained by the extent to which an organization has resources to employ capable individuals to grade website work product. Machine grading tends to be hyper-specific and harsh, with a literal focus on the differences from the specification, often at the pixel level.

What is thus needed is a system that reduces the subjectivity often associated with manually grading the quality of a web site implementation as compared to a design specification.

What is further needed is a system that can rapidly and efficiently grade the quality of a subject implementation, to reduce the time delay and cost associated with prior methods.

What is further needed is a system that can validate skills at scale to filter applicants, allowing recruiters to select among applicants by objectively, immediately and accurately measuring the applicant's ability to build a website to design specification without requiring technical assistance.

### BRIEF DESCRIPTION OF THE DRAWINGS

The features and advantages of the present disclosure will be more fully understood with reference to the following detailed description when taken in conjunction with the accompanying figures, wherein:

FIG. 1 is a flowchart describing a conventional process for web site design.

FIG. 2 a depiction of a sample web page design specification.

FIGS. 3a-3b show an excerpt of a design specification, and a corresponding excerpt of a candidate's testing submission, respectively.

FIG. 4 shows the output of a pixel-by-pixel comparison of FIGS. 3a-3b

FIG. 5 contains a block-level diagram of the components of an exemplary system.

FIGS. 6a-6c shows an exemplary stimulus interface.

FIG. 7 contains a functional diagram of a preferred grading system.

FIGS. 8a-8b show a sample candidate submission and the same candidate submission as interpreted by the grading system after a screenshot capture process.

FIG. 9 shows an exemplary baseline reference screenshot.

FIG. 10 shows an image differential between a baseline image and a candidate submission.

### SUMMARY OF THE INVENTION

In embodiments of the invention, a computer-implemented method for scoring the adherence of web page design to a design template is disclosed comprising the steps of: (1) providing a web-based stimulus that is configured to receive input from the user and provide instruction to the user concerning a testing procedure; (2) providing an assessment web application that is configured to administer an assessment and receive a candidate submission; (3) receiving a candidate submission, injecting the candidate submission in a reference codebase, and rendering the candidate submission in a browser before capturing a plurality of screenshots of the rendered candidate submission; (4) using a mismatch generator to compare the screenshots to a design template, identify areas of difference, visually display those areas in an error color, calculate a ratio of error pixels to non-error pixels and store the result as a mismatch percentage; and (5) storing the plurality of screenshots and mismatch percentage on a remote server device. In embodiments, a score calculator may be used to calculate a final score based upon at least the mismatch percentage.

In embodiments of the invention, a non-transitory computer readable storage medium is disclosed in which one or more sequences of instructions are stored and, when executed by one or more processors, cause the one or more processors to perform a set of operations comprising: (1) providing a web-based stimulus that is configured to receive input from the user and provide instruction to the user concerning a testing procedure; (2) providing an assessment web application that is configured to administer an assessment and receive a candidate submission; (3) receiving a candidate submission, injecting the candidate submission in a reference codebase, and rendering the candidate submission in a browser before capturing a plurality of screenshots of the rendered candidate submission; (4) using a mismatch generator to compare the screenshots to a design template, identify areas of difference, visually display those areas in an error color, calculate a ratio of error pixels to non-error pixels is computed and store as a mismatch percentage; and (5) storing the plurality of screenshots and mismatch percentage on a remote server device.

In embodiments, the error color may be a color not otherwise used in the color palette of the design template. In embodiments, the rendering step is performed by a code intake module configured to download the candidate submission and inject it into a reference codebase.

In embodiments, the screenshots may include at least one of: a full-page screenshot; a screenshot of each section starting from the top of the page; a screenshot of all text on the page masked with a unique color; a screenshot of all images on the page with a unique color different from the text masking color; and a repeat of all captured screenshots.

In embodiments, the web-based stimulus may provide a detailed description of the task to be completed including design guidelines, limitations, grading criteria and other reference material.

### DETAILED DESCRIPTION

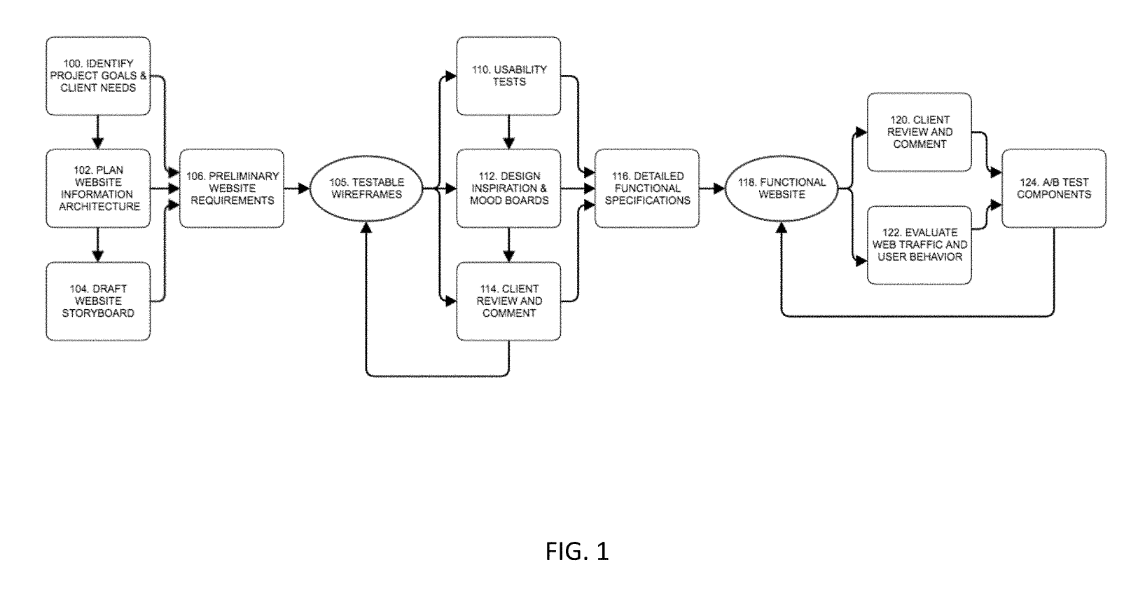

Embodiments of the invention disclose a computer-based, automated grading system that receives human-created source code in a machine-readable format and scores the quality of the subject code against a target design specification. FIG. 1 contains a flowchart describing a conventional process for web site design.

The design and implementation of a web site traditionally begins with an identification (block 100) of the needs and goals of the client or employer, and the intended purpose for the site(s). This may include conceptual steps such as planning the information architecture for the site (block 102) and drafting a storyboard (block 104) mapping the site. A set of preliminary website requirements (block 106) may then be generated.

While a web developer may have a portfolio of templates and building blocks that can be reused for a new project, many clients and employers require a custom design that is in alignment with their brand image or a particular look and feel. The developer must then implement this design as a functional prototype. Here, the developer may be provided with mockups, wireframes, design specifications, or the like, and be asked to implement the same in source code. Depending on the nature of the project, it may be important to adhere very closely to the design specification—without meaningful deviation—to implement the client or employer vision. Usability testing (block 110), mood board (block 112), and client review and comment (block 114) may be further incorporated to generate a detailed functional specification for the site (block 116), describing in detail the site's capabilities, appearance and interactions with users. A functional web site may then be created (block 118).

A period of client review and comment (block 120) along with evaluation of traffic to and within the site and user behavior (block 122) may be utilized to finalize the design.

Identifying qualified candidates to meet these needs may involve techniques such as personal interviews and mock development scenarios, both of which require investment of time on the part of the employer and candidate.

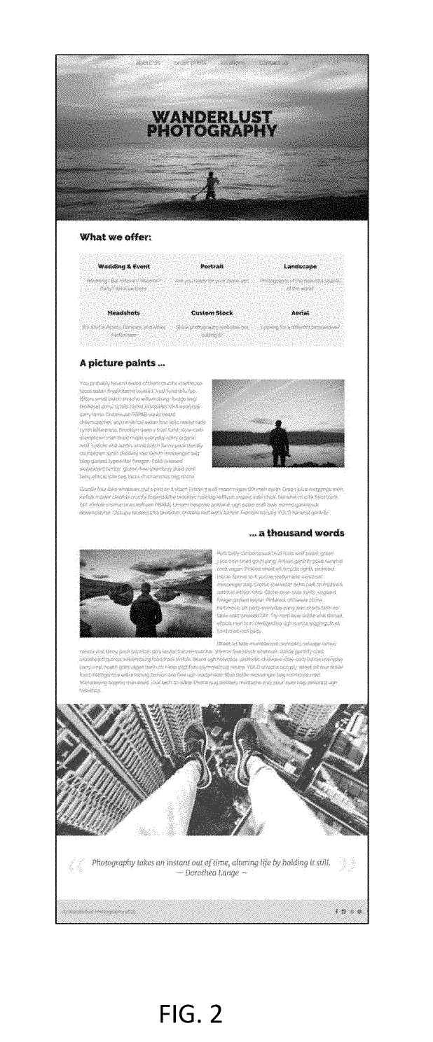

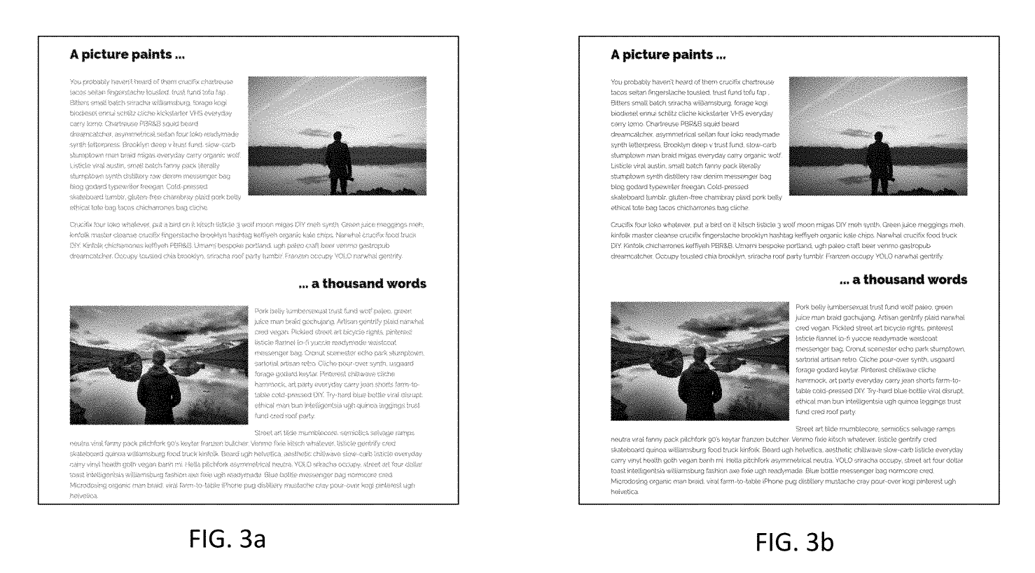

FIG. 2 shows a sample web page design specification as prepared by a designer not involved in implementing the design in source code. In a testing environment, the developer would be expected to implement the design in source code, which would be graded to determine the faithfulness to the original design. FIGS. 3a-3b shows an excerpt of the FIG. 1 design specification, alongside an excerpt of the candidate's work in FIG. 3b. To a human reviewer, the implementation in FIG. 3b appears completely faithful to the specification in FIG. 3a and the reviewer would likely award a perfect score of 100%.

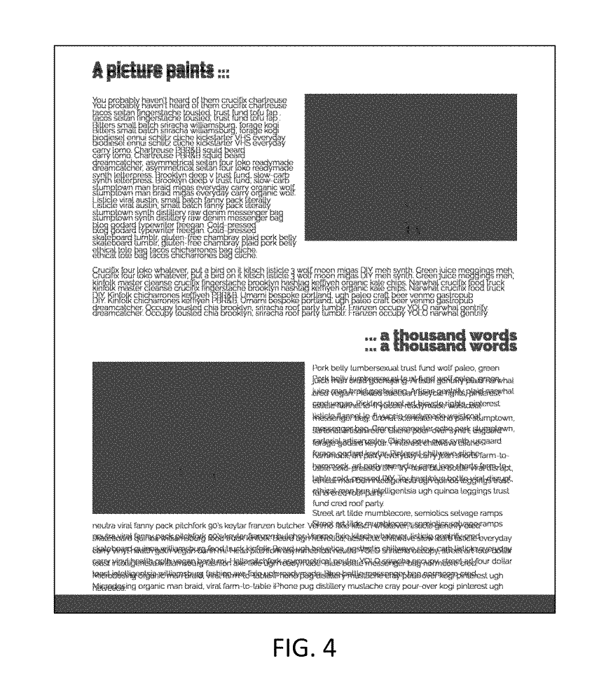

FIG. 4 shows the output of a pixel-by-pixel comparison of FIGS. 3a-3b, which reveals significant variation between the original and the implementation for which a sample reviewing algorithm awarded only 47% score. While the human reviewer scored the implementation too highly, without accounting for the variations, the algorithm-based review scored the implementation too harshly, taking too exact a view of the differences.

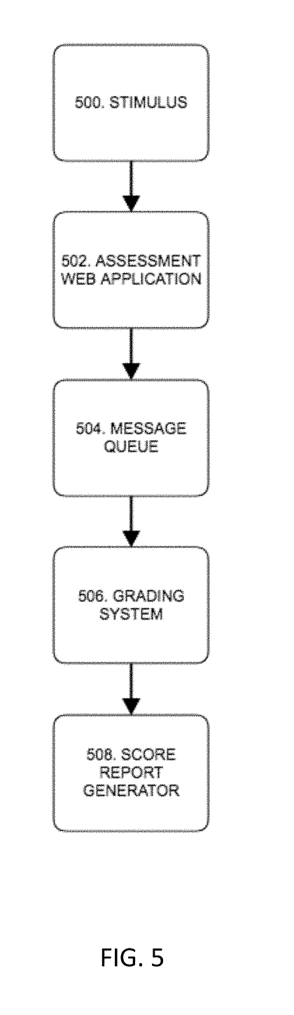

FIG. 5 contains a block-level diagram of the components of an exemplary system.

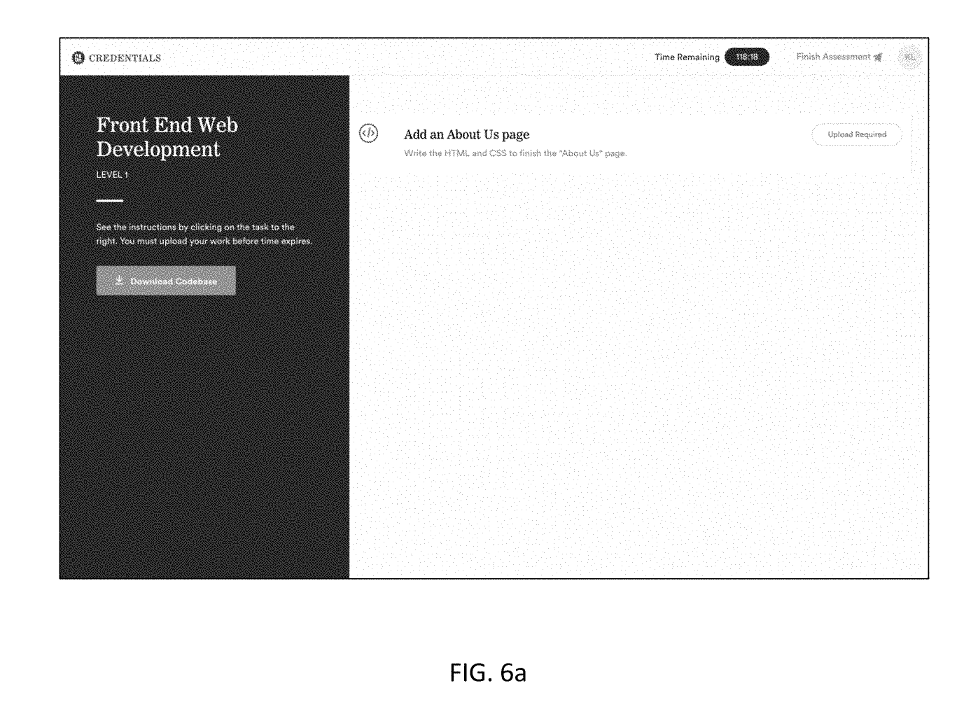

A stimulus 500 may be utilized to provide an initial workspace for the test taker to ensure a common starting point and consistent input into the grading system. Stimulus may be the primary point of contact to the system for the candidate, and provide clear instructions for what work to complete and how to submit it. In embodiments, stimulus may be a web-based portal that the test-taker may access on-site or remotely, and which provides instructions for completing the exercise, provides prompts to user, receives input from the user, and controls user interaction with other modules in the system among other functions. An example stimulus interface is shown in FIGS. 6a-6c. FIG. 6a shows a segment of the stimulus configured to provide the user with a list of tasks for the assessment, implement time restrictions, and control login. FIGS. 6b-6c provide a detailed description of the task to be completed including design guidelines, limitations, grading criteria and other reference material.

Referring again to FIG. 5, an assessment web application (AWA) 502 may be provided to receive code submitted by the candidate. In embodiments, the AWA administers the assessment and allows the candidate to submit work for scoring. After receiving the candidate's work, the AWA may pass it to a grading system 506 using a message queue 504. Once the grading system has completed grading the submission, it will transfer the raw results back to the AWA where the raw results may be used to calculate an overall score based on performance by assessment section.

A score report generator 508 may then receive the data payload from the AWA and populate a score report, which may be sent to the user. In embodiments, a score report may be sent as a hosted URL link via e-mail, SMS or text message, or as an e-mail attachment. Alternatively, candidate scores may be sent to a candidate tracking system that manages various information about candidates.

The grading system utilized with embodiments of the invention will now be described in greater detail. In embodiments, the grading system may be a suite of tools that receives a user submission, performs the comparison to the design template, and assigns a score relative to how close the candidate design follows the design template.

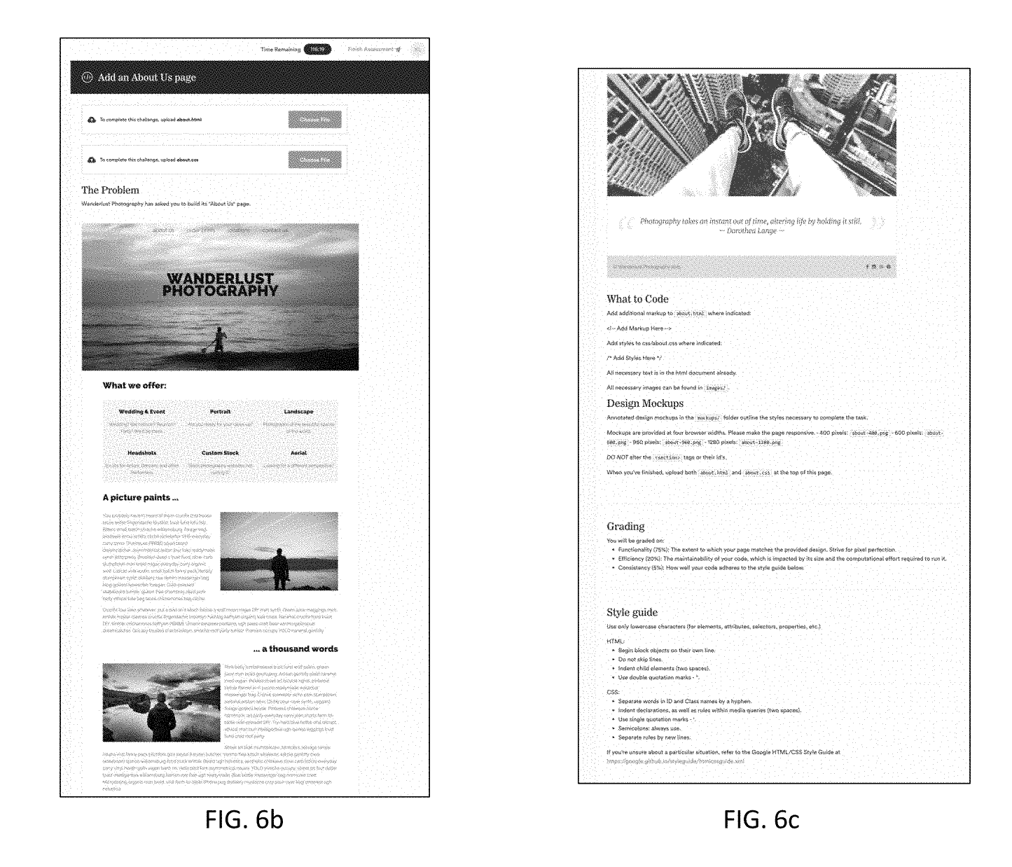

FIG. 7 contains a functional diagram of a preferred grading system. As shown in FIG. 7, an exemplary grading system comprises a series of discrete modules including, but not limited to: a code intake module (710); a high-fidelity screenshot generator (716); screenshot transformer for reducing pixels to patterns (712); mismatch detector (722); and score calculator (724).

In embodiments, the code intake module (710) may receive a candidate submission, either by a direct data transfer from other components of the system, or by reference to a remote location such as a cloud storage server. Once received, the code intake module downloads the submission and injects it into a reference codebase, allowing a web server to serve the resulting web page over a hypertext transfer protocol (HTTP). The resulting web page directly mirrors what the user would be working with in their local development environment. The code intake module may then initiate (714) an instance of a web browser to render the page. In embodiments, a headless instance of a browser may be utilized, i.e., a browser with no user interface for testing purposes. While a full browser instance may be used, a headless browser allows faster testing since the drawing and rendering operations that consume resources and slow testing are not called upon. Screenshots may then be captured by a high-fidelity screenshot generator (716).

In embodiments, a screenshot capture process may include capturing the following: (1) a full-page screenshot; (2) a screenshot of each section starting from the top of the page; (3) a screenshot of all text on the page masked with a unique color; (4) a screenshot of all images on the page with a unique color different from the text masking color; and (5) a repeat of all captured screenshots. This will generate images that will express the overall location of each image and block of text.

A mismatch generator (722) may be used to compare the candidate submission and reference to generate a differential. Areas of mismatch will result in a pixel of a reference error color not used in the color palette of the web page design. The image differential may appear as the baseline screenshot with and overlay of the incorrect pixels in the reference color. The ratio of error pixels related to non-error pixels is computed and stored as a mismatch percentage.

The resulting output, including raw screenshots and masked screenshots at each breakpoint, may then be archived and uploaded to a storage device (720). A results payload may be generated with all mismatch percentages and a reference to the remote location of the uploaded archive to the score calculator (724) before being returned to the AWA (700).

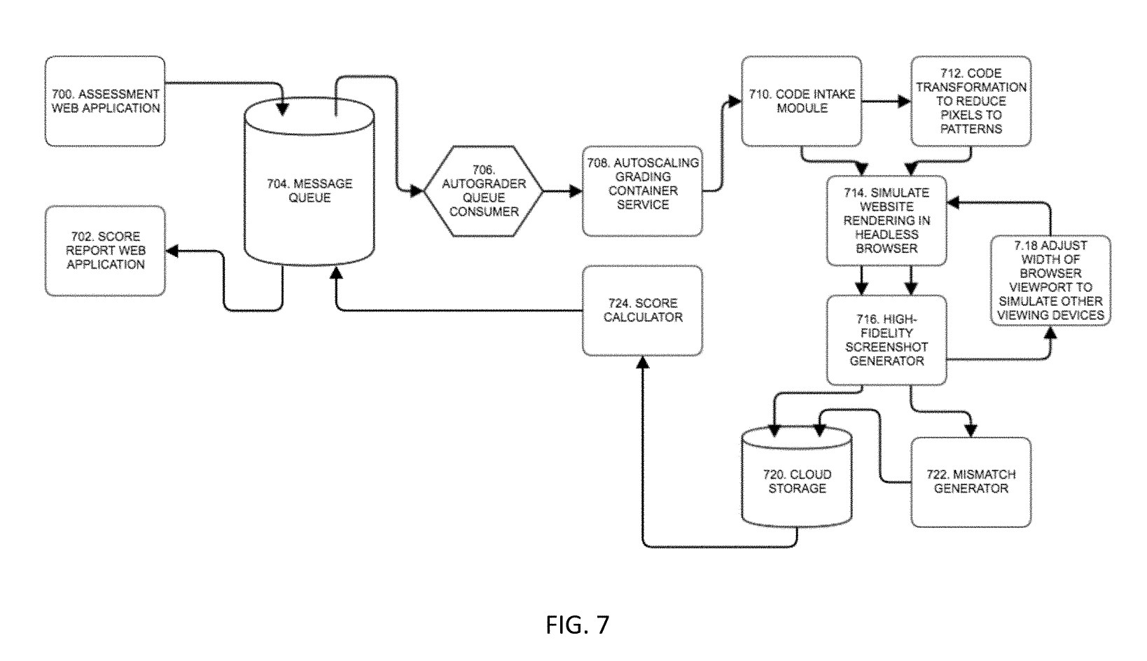

FIG. 8a shows a sample candidate submission. FIG. 8b shows the same candidate submission as interpreted by the grading system after a screenshot capture process in which text has been masked in light gray, and images masked in dark gray.

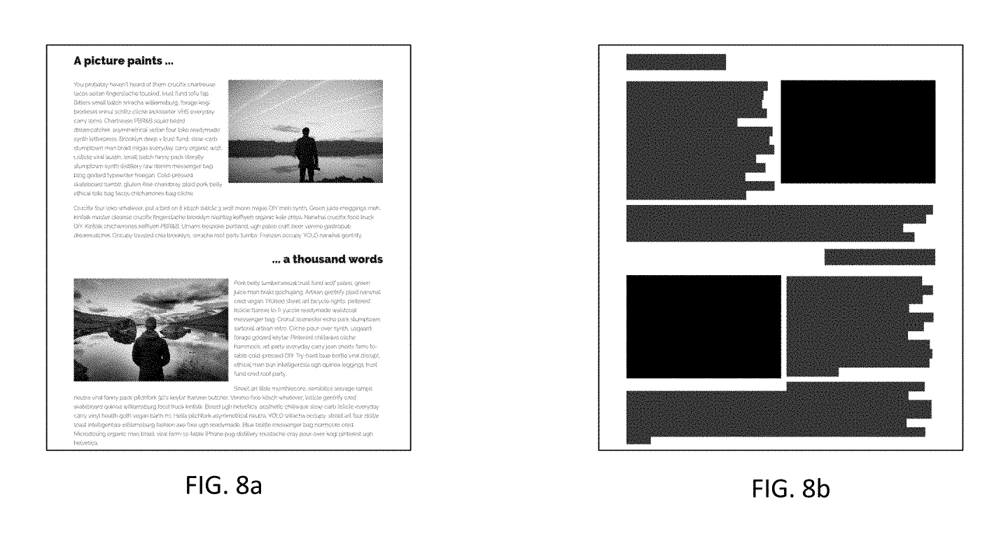

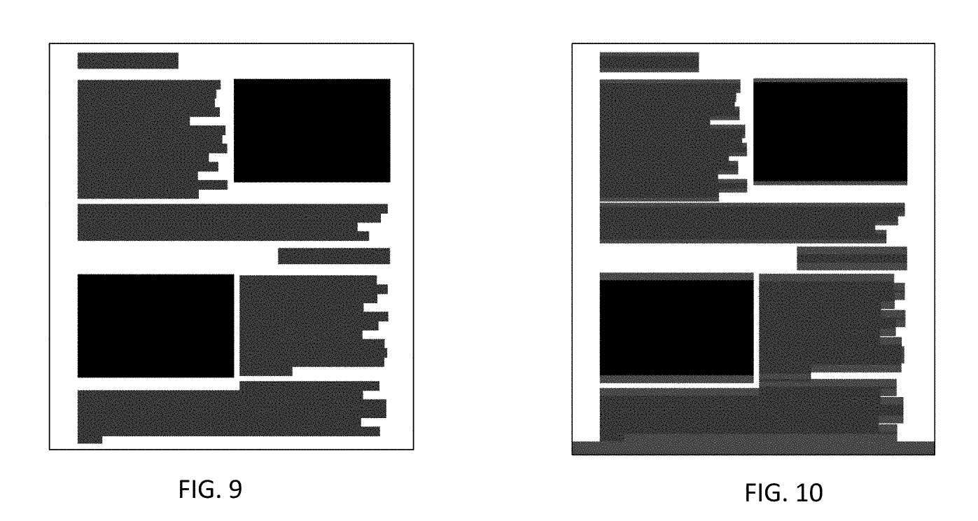

Before testing any candidate, a baseline reference set of masked screenshots may be prepared on a per-pixel basis. An exemplary baseline reference screenshot is shown in FIG. 9. These baseline reference screenshots may then be compared to the candidate screenshots to generate an image differential, an example of which is shown in FIG. 10.

Where the candidate submission and reference match, the pixels in the image differential will match. Areas of mismatch will result in a pixel of a reference error color not used in the color palette of the web page design. The image differential may appear as the baseline screenshot with and overlay of the incorrect pixels in the reference color. The ratio of error pixels related to non-error pixels is computed and stored as a mismatch percentage.

The resulting output, including raw screenshots and masked screenshots at each breakpoint, may then be archived and uploaded to a storage device. A results payload may be generated with all mismatch percentages and a reference to the remote location of the uploaded archive and returned to the AWA.

Prototype embodiments of the invention have resulted in increased accuracy of testing. Where traditional scoring would have evaluated the candidate submission of FIG. 8a at only 47% accuracy, the system of the present invention rated it at 85%.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A computer-implemented method for scoring the adherence of web page design to a design template, comprising:
providing a web-based stimulus that is configured to receive input from the user and provide instruction to the user concerning a testing procedure;
providing an assessment web application that is configured to administer an assessment and receive a candidate submission;
receiving a candidate submission, injecting the candidate submission in a reference codebase, and rendering the candidate submission in a browser before capturing a plurality of screenshots of the rendered candidate submission;
using a mismatch generator to compare the screenshots to a design template, identify areas of difference, visually display those areas in an error color, calculate a ratio of error pixels to non-error pixels and store the result as a mismatch percentage; and
storing the plurality of screenshots and mismatch percentage on a remote server device.

2. The method of claim 1 wherein the error color is a color not otherwise used in the color palette of the design template.

3. The method of claim 1 wherein the rendering step is performed by a code intake module configured to download the candidate submission and inject it into a reference codebase.

4. The method of claim 1 further comprising the step of using a score calculator to calculate a final score based upon at least the mismatch percentage.

5. The method of claim 1 wherein the screenshots include at least one of: a full-page screenshot; a screenshot of each section starting from the top of the page; a screenshot of all text on the page masked with a unique color; a screenshot of all images on the page with a unique color different from the text masking color; and a repeat of all captured screenshots.

6. The method of claim 1 wherein the web-based stimulus further provides detailed description of the task to be completed including design guidelines, limitations, grading criteria and other reference material.

7. A non-transitory computer readable storage medium storing one or more sequences of instructions, when executed by one or more processors, to cause the one or more processors to perform a set of operations comprising:
providing a web-based stimulus that is configured to receive input from the user and provide instruction to the user concerning a testing procedure;
providing an assessment web application that is configured to administer an assessment and receive a candidate submission;
receiving a candidate submission, injecting the candidate submission in a reference codebase, and rendering the candidate submission in a browser before capturing a plurality of screenshots of the rendered candidate submission;
using a mismatch generator to compare the screenshots to a design template, identify areas of difference, visually display those areas in an error color, calculate a ratio of error pixels to non-error pixels is computed and store as a mismatch percentage; and
storing the plurality of screenshots and mismatch percentage on a remote server device.

8. The non-transitory computer readable medium according to claim 7 wherein the error color is a color not otherwise used in the color palette of the design template.

9. The non-transitory computer readable medium according to claim 7 wherein the rendering step is performed by a code intake module configured to download the candidate submission and inject it into a reference codebase.

10. The non-transitory computer readable medium according to claim 7 further comprising the step of using a score calculator to calculate a final score based upon at least the mismatch percentage.

11. The non-transitory computer readable medium according to claim 7 wherein the screenshots include at least one of: a full-page screenshot; a screenshot of each section starting from the top of the page; a screenshot of all text on the page masked with a unique color; a screenshot of all images on the page with a unique color different from the text masking color; and a repeat of all captured screenshots.

12. The non-transitory computer readable medium according to claim 7 wherein the web-based stimulus further provides detailed description of the task to be completed including design guidelines, limitations, grading criteria and other reference material.
